(19) United States
(12) Patent Application Publication
(10) Pub. No.: US 2020/0047779 A1
(43) Pub. Date: Feb. 13, 2020

(54) Vehicle size measurement apparatus and vehicle size measuring method

(71) Applicant: HITACHI HIGH-TECH FINE SYSTEMS CORPORATION, SAITAMA (JP)

(72) Inventor: UENO TAKETO, SAITAMA (JP)

(73) Assignee: HITACHI HIGH-TECH FINE SYSTEMS CORPORATION, SAITAMA (JP)

(21) Appl. No.: 16/534,848

(22) Filed: Aug. 7, 2019

(30) Foreign Application Priority Data
Aug. 7, 2018 (JP) 2018-148864

(51) Int. Cl. B61K 9/02; G01B 11/02; G01B 9/02; G01B 11/10; G01B 11/24; B61K 9/12

(52) U.S. Cl. CPC B61K 9/02; G01B 11/026; G01B 9/02024; G01B 9/02014; G01B 11/2441; B61K 9/12; G01B 11/10

(57) ABSTRACT

An object of the invention is to measure an outside size of the vehicle accurately while running the vehicle. A plurality of the 1st sensors 25, 26 irradiate inspection lights to a plurality of places (4a) of the vehicle 4 of a railroad and output measurement signals which show positions and distances by receiving lights from a plurality of the places of the vehicle 4. The 2nd sensor 27, 28 or 29 irradiates an inspection light to an outside surface of the vehicle 4 and outputs a measurement signal which shows a position and a distance by receiving a light from the outside surface of the vehicle 4. The control equipment 30 or the processing equipment 41 processes the measurement signals outputted from a plurality of the 1st sensors 25, 26, detects positions and heights of a plurality of the places of the vehicle 4, processes the measurement signal outputted from the 2nd sensor 27, 28 or 29, and detects the outside size of the vehicle 4. And the control equipment 30 or the processing equipment 41 calculates amounts of a deviation of the outside surface of the vehicle 4 due to a swing of the vehicle 4 based on amounts of fluctuations of the detected positions and heights of a plurality of the places of the vehicle 4, and corrects the detected outside size of the vehicle 4 according to the calculated amounts of the deviation.

### CROSS REFERENCE TO RELATED APPLICATIONS

This application is a U.S. nonprovisional application which claims priority to Japanese Patent Application No. 2018-148864, filed on Aug. 7, 2018. This application is also related to Japanese Patent Application No. 2012-007950, published on Jan. 12, 2012 and Japanese Patent Application No. 2007-223473, published on Sep. 6, 2007. The contents of each of the aforementioned patent applications are hereby incorporated by reference in their entirety.

### TECHNICAL FIELD OF THE INVENTION

Present invention relates to a vehicle size measurement apparatus and a vehicle size measuring method, which measure outside sizes of a vehicle of a railroad. In addition, heights of the bottom of various kinds of apparatus prepared under a floor of the vehicle (henceforth “the apparatus under the vehicle floor”) are also included in the outside sizes of the vehicle.

### BACKGROUND OF THE INVENTION

A duty of periodical inspections and maintenances is imposed upon the vehicle of the railroad. For example, in an inspection before everyday operation, inspection workers inspect pre-determined items on the vehicle, which has stopped on rails, by hand. About outside sizes of the vehicle, vehicle limits are defined. A patent reference 1 shows the conventional technology which measures the outside sizes of the vehicle in high precision. On the other hand, a patent reference 2 shows the inspection method and apparatus which obtain a long image of the moving vehicle and inspect the vehicle by combining other kinds of the information from sensors in relation to the image.

### SUMMARY AND OBJECT OF THE INVENTION

In the vehicle under run, deviations of positions and heights of outside surfaces of the vehicle occur due to gaps in upper/lower and left-side/right-side directions or an inclination, which are caused by a swing of the vehicle. The technology shown in the patent reference 1 gives no consideration to the deviations of the outside surfaces of the vehicle due to the swing of the vehicle. Especially, in the bottom of the floor of the vehicle of the railroad, various kinds of the apparatus under the vehicle floor, such as compressors and air tanks, etc. are installed. However, as for the apparatus under the vehicle floor, fixation may loosen owing to the vibration while running, etc., a height of the apparatus under the vehicle floor may become lower than a regulation value, and when the worst, the apparatus under the vehicle floor itself or its cover may drop out. Then, conventionally, the inspection workers were periodically inspecting and measuring the height of the apparatus under the vehicle floor by hand. Therefore, inspection works took time and efforts, and there was a problem of measurement accuracy variations in each inspection worker. On the other hand, in the technology shown in the patent reference 2, although the apparatus temperature, unusual sounds, vibrations, electric field intensity, or magnetic field intensity were measured using the sensors, no consideration is given to the height of the apparatus under the vehicle floor.

An object of the present invention is to measure the outside size of the vehicle accurately while running the vehicle.

### DISCLOSURE OF THE INVENTION

The feature of a vehicle size measurement apparatus according to the present invention is to comprise a plurality of the 1st sensors which irradiate inspection lights to a plurality of places of a vehicle of a railroad and output measurement signals which show positions and distances by receiving lights from a plurality of the places of the vehicle, the 2nd sensor which irradiates an inspection light to an outside surface of the vehicle and outputs a measurement signal which shows a positions and a distance by receiving a light from the outside surface of the vehicle, and control and processing equipment which controls a plurality of the 1st sensors and the 2nd sensor, processes the measurement signal outputted from the 2nd sensor, and detects an outside size of the vehicle, wherein the control and processing equipment processes the measurement signals outputted from a plurality of the 1st sensors, detects positions and heights of a plurality of the places of the vehicle, calculates amounts of a deviation of the outside surface of the vehicle due to a swing of the vehicle based on amounts of fluctuations of the detected positions and heights of a plurality of the places of the vehicle, and corrects the detected outside size of the vehicle according to the calculated amounts of the deviation.

The feature of a vehicle size measuring method according to the present invention is to comprise the following steps of: using a plurality of the 1st sensors, irradiating inspection lights to a plurality of places of a vehicle of a railroad and outputting measurement signals which show positions and distances by receiving lights from a plurality of the places of the vehicle, using the 2nd sensor, irradiating an inspection light to an outside surface of the vehicle and outputting a measurement signal which shows a positions and a distance by receiving a light from the outside surface of the vehicle, processing the measurement signals outputted from a plurality of the 1st sensors and detecting positions and heights of a plurality of the places of the vehicle, processing the measurement signal outputted from the 2nd sensor and detecting an outside size of the vehicle, calculating amounts of a deviation of the outside surface of the vehicle due to a swing of the vehicle based on amounts of fluctuations of the detected positions and heights of a plurality of the places of the vehicle, and correcting the detected outside size of the vehicle according to the calculated amounts of the deviation.

In the vehicle under run, the deviations of positions and heights of the outside surfaces of the vehicle occur due to gaps in upper/lower and left-side/right-side directions or an inclination, which are caused by the swing of the vehicle. Amounts of the deviations of the outside surfaces of the vehicle due to the swing of the vehicle vary depending on swinging levels of the vehicle and the positions of the outside surfaces of the vehicle in a rails width direction and their heights. By calculating the amounts of the deviation of the outside surface of the vehicle due to the swing of the vehicle based on the amounts of the fluctuations of the detected positions and heights of a plurality of the places of the vehicle, and by correcting the detected outside size of the vehicle according to the calculated amounts of the deviation, the outside size of the vehicle can be measured accurately without any influence of the swing of the vehicle under run.

The further feature of the vehicle size measurement apparatus according to the present invention is to comprise body number detection equipment which detects the information peculiar to each vehicle and given to the vehicle (the information for specifying each vehicle, such as vehicle numbers or the train organization information, etc., henceforth “the body number information”), wherein the control and processing equipment processes the data of the outside size of the vehicle with relating to the body number information detected by the body number detection equipment. The further feature of the vehicle size measuring method according to the present invention is to comprise the following steps of: using body number detection equipment, detecting the body number information given to the vehicle, and processing the data of the outside size of the vehicle with relating to the body number information detected by the body number detection equipment. By checking the body number information, a measurement result can be distinguished from results of other vehicles.

The further feature of the vehicle size measurement apparatus according to the present invention is to comprise a vehicle position sensor which detects a position of the vehicle and outputs detection signals at every time when the vehicle moves a predetermined distance, wherein the control and processing equipment carries out a synchronous control of a plurality of the 1st sensors and the 2nd sensor based on the detection signals outputted from the vehicle position sensor. The further feature of the vehicle size measuring method according to the present invention is to comprise the following steps of: using a vehicle position sensor, detecting a position of the vehicle and outputting detection signals at every time when the vehicle moves a predetermined distance, and carrying out a synchronous control of a plurality of the 1st sensors and the 2nd sensor based on the detection signals outputted from the vehicle position sensor. The amounts of the deviation of the outside surface of the vehicle due to the swing of the vehicle are changing time after time depending on a travelling movement of the vehicle. By using the vehicle position sensor, detecting the position of the vehicle, outputting the detection signals at every time when the vehicle moves the predetermined distance, and carrying out the synchronous control of a plurality of the 1st sensors and the 2nd sensor based on the detection signals outputted from the vehicle position sensor, the amounts of the deviation of the outside surface of the vehicle due to the swing of the vehicle can be measured accurately.

The further feature of the vehicle size measurement apparatus according to the present invention is that the 2nd sensor irradiates the inspection light below to a floor of the vehicle and outputs the measurement signal which shows the position and the distance by receiving the light below from the floor of the vehicle, and the control and processing equipment processes the measurement signal outputted from the 2nd sensor and detects a height of the bottom of an apparatus under the vehicle floor, which is prepared under the floor of the vehicle. The further feature of the vehicle size measuring method according to the present invention is to comprise the following steps of: using the 2nd sensor, irradiating the inspection light below to a floor of the vehicle and outputting the measurement signal which shows the position and the distance by receiving the light below from the floor of the vehicle, processing the measurement signal outputted from the 2nd sensor, and detecting a height of the bottom of an apparatus under the vehicle floor, which is prepared under the floor of the vehicle. The height of the bottom of the apparatus under the vehicle floor can be measured accurately while running the vehicle.

The further feature of the vehicle size measurement apparatus according to the present invention is that the control and processing equipment processes the measurement signal outputted from the 2nd sensor, detects the heights of the bottom of the apparatus under the vehicle floor at the same interval, creates an image which shows the distribution of the heights of the bottom of the apparatus under the vehicle floor, and specifies measurement points, which are pointed out beforehand, on the created image. The further feature of the vehicle size measuring method according to the present invention is to comprise the following steps of: processing the measurement signal outputted from the 2nd sensor, detecting the heights of the bottom of the apparatus under the vehicle floor at the same interval, creating an image which shows the distribution of the heights of the bottom of the apparatus under the vehicle floor, and specifying measurement points, which are pointed out beforehand, on the created image. By creating the image which shows the distribution of the heights of the bottom of the apparatus under the vehicle floor, and specifying the measurement points, which are pointed out beforehand, on the created image, the inspection worker can arbitrarily point out the measurement points beforehand.

The further feature of the vehicle size measurement apparatus according to the present invention is that the control and processing equipment creates the image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of the vehicle. The further feature of the vehicle size measuring method according to the present invention is to comprise the following steps of: creating the image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of the vehicle. The image can be obtained accurately without any influence of the swing of the vehicle. Therefore, it is possible to detect differences by comparing the image with another image which was created about the same vehicle before.

The further feature of the vehicle size measurement apparatus according to the present invention is to comprise a memory which memorizes the data of the height of the bottom of the apparatus under the vehicle floor, wherein the control and processing equipment judges whether the measured height of the bottom of the apparatus under the vehicle floor is less than a predetermined value from a datum point which was beforehand set on the vehicle, and memorizes a judgment result in the memory. The further feature of the vehicle size measuring method according to the present invention is to comprise the following steps of: preparing a memory which memorizes the data of the height of the bottom of the apparatus under the vehicle floor, judging whether the measured height of the bottom of the apparatus under the vehicle floor is less than a predetermined value from a datum point which was beforehand set on the vehicle, and memorizing a judgment result in the memory. In the vehicle under run, since the deviations of the heights of the bottom of the apparatus under the vehicle floor occur due to the swing of the vehicle, a conventional way of judging good/bad of the measurement result based on a height of an upper surface of the rail is not suitable. Therefore, the measurement result is judged good or bad based on a distance from the datum point which was beforehand set on the vehicle. The datum point is, for example, a middle point of a left-side edge and a right-side edge in a front/rear view of the vehicle. The good/bad judgement of the measurement result can be checked with the data memorized in the memory.

The further feature of the vehicle size measurement apparatus according to the present invention is to comprise a display which displays the height of the bottom of the apparatus under the vehicle floor, wherein the control and processing equipment displays the judgment result on the display. The further feature of the vehicle size measuring method according to the present invention is to comprise the following steps of: preparing a display which displays the height of the bottom of the apparatus under the vehicle floor, and displaying the judgment result on the display. The inspection worker can easily know the good/bad judgement of the measurement result by checking displayed contents.

### Effect of the Invention

According to the present invention, it is possible to measure the outside size of the vehicle accurately while running the vehicle.

Furthermore, by using the body number detection equipment, detecting the body number information given to the vehicle, and processing the data of the outside size of the vehicle with relating to the body number information detected by the body number detection equipment, the measurement result can be distinguished from results of other vehicles.

Furthermore, by using the vehicle position sensor, detecting the position of the vehicle, outputting the detection signals at every time when the vehicle moves the predetermined distance, and carrying out the synchronous control of a plurality of the 1st sensors and the 2nd sensor based on the detection signals outputted from the vehicle position sensor, the amounts of the deviation of the outside surface of the vehicle due to the swing of the vehicle can be measured accurately.

Furthermore, by using the 2nd sensor, irradiating the inspection light below to the floor of the vehicle, outputting the measurement signal which shows the position and the distance by receiving the light below from the floor of the vehicle, processing the measurement signal outputted from the 2nd sensor, and detecting the height of the bottom of the apparatus under the vehicle floor, which is prepared under the floor of the vehicle, the height of the bottom of the apparatus under the vehicle floor can be measured accurately while running the vehicle.

Furthermore, by creating the image which shows the distribution of the heights of the bottom of the apparatus under the vehicle floor, and specifying the measurement points, which are pointed out beforehand, on the created image, the inspection worker can arbitrarily point out the measurement points beforehand.

Furthermore, by creating the image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of the vehicle, the image can be obtained accurately without any influence of the swing of the vehicle. Therefore, it is possible to detect differences by comparing the image with another image which was created about the same vehicle before.

Furthermore, by preparing the memory which memorizes the data of the height of the bottom of the apparatus under the vehicle floor, judging whether the measured height of the bottom of the apparatus under the vehicle floor is less than the predetermined value from the datum point which was beforehand set on the vehicle, and memorizing the judgment result in the memory, the good/bad judgement of the measurement result can be checked with the data memorized in the memory.

Furthermore, by preparing the display which displays the height of the bottom of the apparatus under the vehicle floor, and displaying the judgment result on the display, the inspection worker can easily know the good/bad judgement of the measurement result by checking the displayed contents.

### BRIEF DESCRIPTION OF THE DRAWINGS

FIG. 1 A diagram showing a schematic structure of the vehicle size measurement apparatus according to an embodiment of the present invention

FIG. 2 A diagram showing an arrangement example of the vehicle detection unit, the height measurement unit, and the vehicle width/vehicle height measurement unit

FIG. 3A is a perspective view showing an example of the vehicle detection unit, and FIG. 3B is a perspective view showing a configuration of the 1st sensors and the 2nd sensors.

FIG. 4A is a top view showing an arrangement example of each sensor of the height measurement unit, and FIG. 4B is a front view showing the arrangement example of each sensor of the height measurement unit.

FIG. 5A is a front view showing another arrangement example of each sensor of the height measurement unit, and FIG. 5B is a front view showing further arrangement example of each sensor of the height measurement unit.

FIG. 6 A flowchart showing operations of the vehicle size measurement apparatus according to the embodiment of the present invention

FIG. 7 A flowchart of the data-processing operations according to the embodiment of the present invention

FIG. 8 A diagram showing a state of the vehicle without the swing

FIG. 9 A diagram showing a state of the vehicle when the swing occurs

FIG. 10 A drawing for explaining how to calculate the amounts of the deviation of the bottom of the apparatus under the vehicle floor due to the swing of the vehicle

FIGS. 11A, 11B, 11C, and 11D A drawing for explaining an example way of pointing out the measurement points, FIG. 11A is a side view of the vehicle, FIG. 11B is a bottom view of the vehicle, FIG. 11C shows a display screen of the display and FIG. 11D shows an example of the data memorized in the memory

FIG. 12 A flowchart of the data-processing operations according to another embodiment of the present invention

### DETAILED DESCRIPTION OF PREFERRED EMBODIMENTS

### Embodiments

### Structure of Vehicle Size Measurement Apparatus

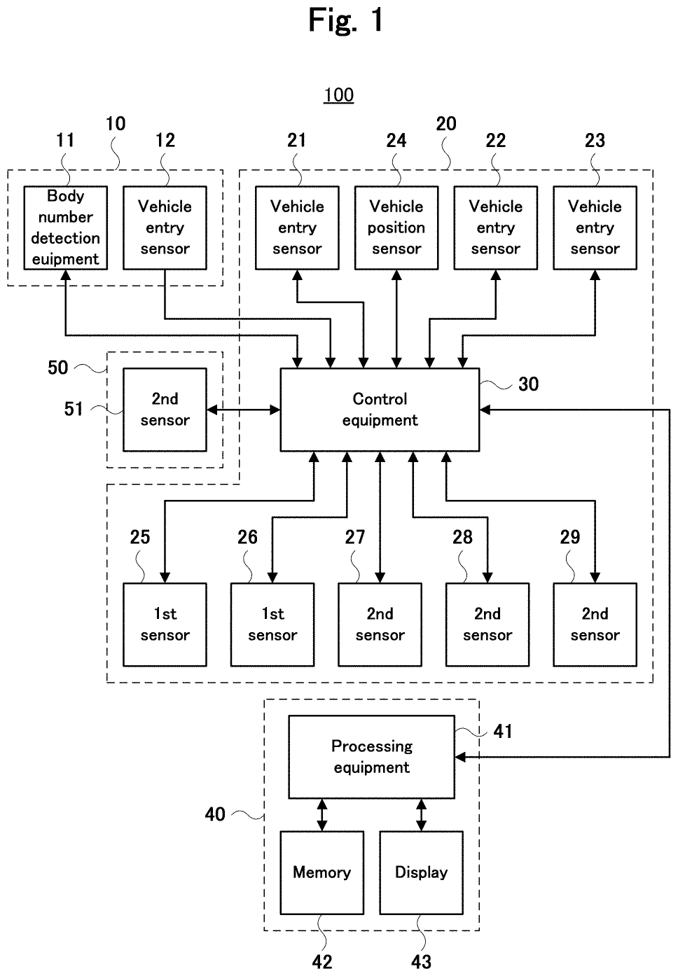

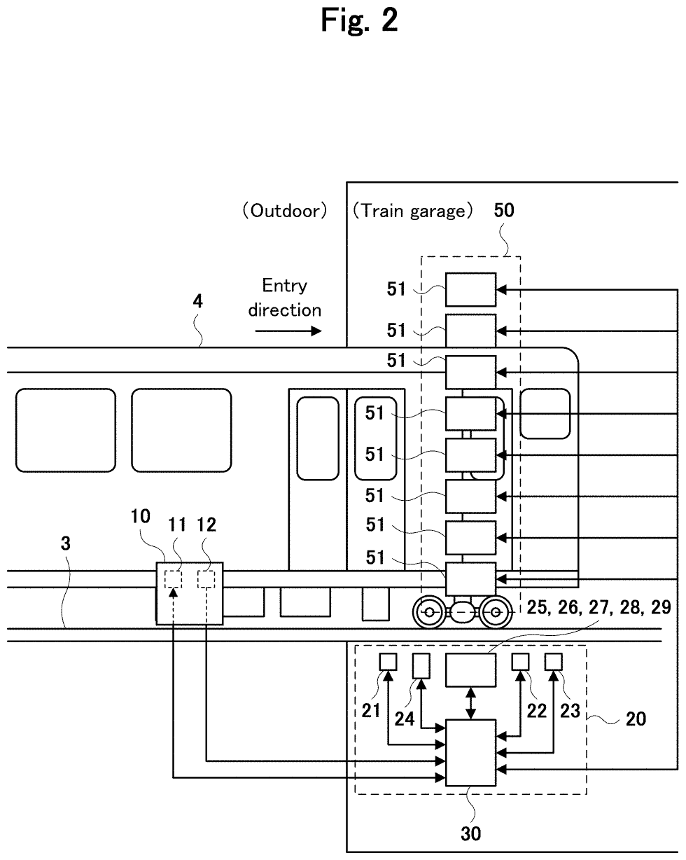

FIG. 1 is a diagram showing a schematic structure of the vehicle size measurement apparatus according to an embodiment of the present invention. The vehicle size measurement apparatus 100 of the present embodiment is configured to include a vehicle detection unit 10, a height measurement unit 20, a processing unit 40, and a vehicle width/vehicle height measurement unit 50. In the present embodiment, the vehicle detection unit 10 is prepared beside rails on which a vehicle runs, and the height measurement unit 20 is prepared mainly under the rails. FIG. 2 is s diagram showing an arrangement example of the vehicle detection unit 10, the height measurement unit 20, and the vehicle width/vehicle height measurement unit 50. FIG. 2 shows the example of arranging the height measurement unit 20 inside a train garage into which a vehicle 4 enters, and the vehicle detection unit 10 is arranged outdoor near an entrance of the train garage. The processing unit 40 is arranged in an office, etc. where inspection workers work. Inside the train garage, the vehicle width/vehicle height measurement unit 50 is arranged for surrounding side surfaces and a roof of the vehicle 4 running on the rails 3.

According to the example shown in FIG. 2, the vehicle size measurement apparatus 100 can measure an outside size of the vehicle 4 at every time when the vehicle 4 enters into the train garage. And, in a case of arranging the vehicle detection unit 10 and a part of the height measurement unit 20 also at symmetric places of FIG. 2, the outside size measurement of the vehicle 4 can be carried out at every time when the vehicle 4 enters into and exits from the train garage. However, the present invention is not limited to these, the vehicle detection unit 10, the height measurement unit 20 and the vehicle width/vehicle height measurement unit 50 of the vehicle size measurement apparatus 100 can be arranged at anywhere near the rails 3 on which the vehicle 4 runs.

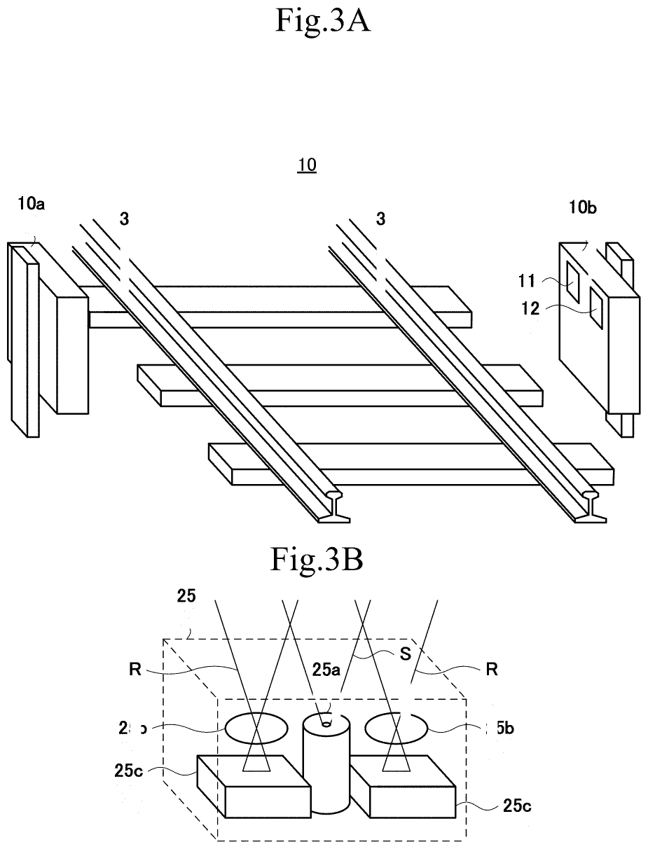

In FIG. 1, the vehicle detection unit 10 is configured to include body number detection equipment 11 and a vehicle entry sensor 12. FIG. 3A is a perspective view showing an example of the vehicle detection unit 10. The vehicle detection unit 10 of this example consists of a light irradiating portion 10a and a light receiving portion 10b. The light irradiating portion 10a and the light receiving portion 10b are arranged face to face while positioning the rails 3 between them. The light irradiating portion 10a irradiates an inspection light such as a laser beam, etc. to the vehicle entry sensor 12 of the light receiving portion 10b. The vehicle entry sensor 12 detects presence of the vehicle by receiving no inspection light which is irradiated from the light irradiating portion 10a but shut out by the vehicle. A reflection type sensor, which irradiates an inspection light to the vehicle and detects the vehicle by receiving a reflection light from the vehicle, or a distortion sensor, which detects the vehicle by measuring distortions of the rails, and the like also can be used as the vehicle entry sensor.

The body number detection equipment 11 in the light receiving portion 10b consists of, for example, a camera and an image processing device, and it obtains an image of the body number written on a side surface of the vehicle and read the body number information.

In FIG. 1, the height measurement unit 20 is configured to include vehicle entry sensors 21, 22, 23, vehicle position sensor 24, the 1st sensors 25, 26, the 2nd sensors 27, 28, 29, and control equipment 30. The reflection type sensor which irradiates the inspection light to the vehicle and detects the vehicle by receiving the reflection light from the vehicle is used as the vehicle entry sensors 21, 22, 23 of the height measurement unit 20. However, a transmission type sensor such as the one shown in FIG. 3 or the distortion sensor, which detects the vehicle by measuring distortions of the rails, and the like can be used. The vehicle position sensor 24 is, for example, a Doppler type position sensor which irradiates a laser light, microwaves, ultrasonic waves, etc. to the vehicle, and measures moving speed of the vehicle with frequency changes of a reflection light or reflection waves from the vehicle, and then generates detection pulses at every time when the vehicle moves a predetermined distance.

The 1st sensors 25, 26 and the 2nd sensors 27, 28, 29 are sensors for obtaining the position information and the distance information of measurement objects. FIG. 3B is a perspective view showing a configuration of the 1st sensors and the 2nd sensors. FIG. 3A shows the 1st sensor 25, and configurations of the 1st sensors 26 and the 2nd sensors 27, 28, 29 are the same as that of the 1st sensors 25.

The 1st sensor 25 is configured to include a laser light source 25a, a condenser lens 25b, and a light receiving element 25c. The laser light source 25a consists of, for example, a laser diode and a light irradiation lens, etc. and generates the inspection light S. The inspection light S generated from the laser light source 25a is irradiated to the vehicle, and the reflection light R from the vehicle is condensed by the condenser lens 25b and received by a light receiving surface of the light receiving element 25c. The light receiving element 25c outputs measurement signals depending on the intensity of the light received by the light receiving surface

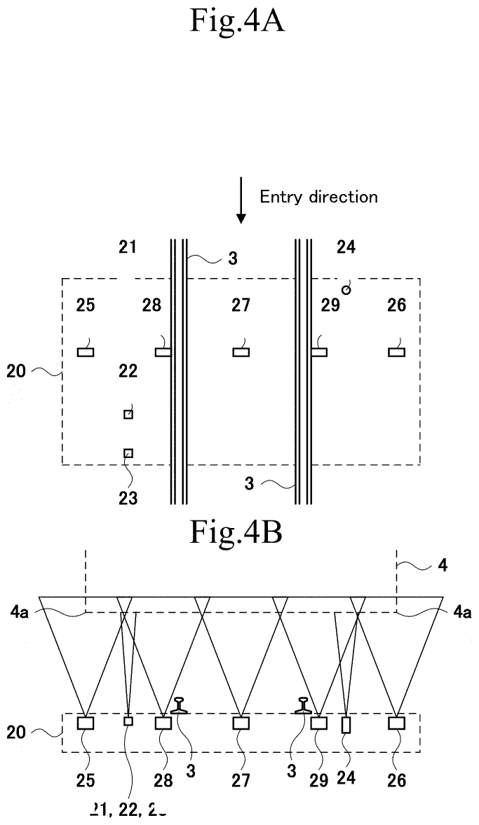

FIG. 4A is a top view showing an arrangement example of each sensor of the height measurement unit 20, and FIG. 4B is a front view showing the arrangement example of each sensor of the height measurement unit 20. In FIG. 4A, the vehicle entry sensors 21, 22, 23 of this example are prepared at one side of two rails 3 and arranged at different positions in a vehicle entry direction. The 1st sensors 25, 26 are prepared at both sides of two rails 3 and arranged at the same positions in the vehicle entry direction. The 2nd sensors 27, 28, 29 are prepared in a row orthogonal to the rails 3 and arranged at the same position of the 1st sensors 25, 26 in the vehicle entry direction. The vehicle position sensor 24 is prepared at another side of two rails 3 and arranged at the same position of the vehicle entry sensors 21.

In FIG. 4A, the 1st sensors 25, 26 are placed under each side edge 4a of the vehicle 4, which is shown with a broken line, respectively. The 1st sensors 25, 26 irradiate the inspection lights to the bottom of the vehicle 4, which includes each side edge 4a, and output the measurement signals which show positions and distances of the measurement objects by receiving the reflection lights from the vehicle 4. On the other hand, the 2nd sensors 27, 28, 29 irradiate the inspection lights below to a floor of the vehicle 4 and output the measurement signals which show the positions and the distances of the measurement objects by receiving the lights below from the floor of the vehicle 4. In FIG. 4B, triangle shapes drawn above the 1st sensors 25, 26 and the 2nd sensors 27, 28, 29 show the inspection lights irradiated from each sensor.

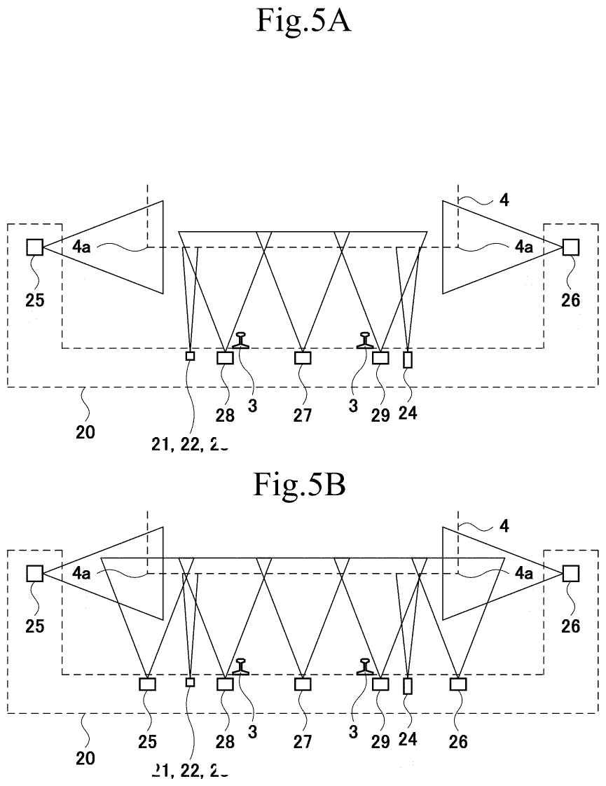

FIG. 5B is a front view showing another arrangement example of each sensor of the height measurement unit 20, and FIG. 5B is a front view showing further arrangement example of each sensor of the height measurement unit 20. In the example shown in FIG. 5A, the 1st sensors 25, 26 are prepared beside each side edge 4a of the vehicle 4. In the example shown in FIG. 5B, two of the 1st sensors 25 are prepared under and beside one side edge 4a of the vehicle 4, and two of the 1st sensors 26 are prepared in the same way.

In FIG. 1, the control equipment 30 is configured with a computer, or a sequencer, or dedicated circuits, etc. The control equipment 30 controls the body number detection equipment 11 of the vehicle detection unit 10, the vehicle entry sensors 21, 22, 23, the vehicle position sensor 24, the 1st sensors 25, 26, and the 2nd sensors 27, 28, 29. The control equipment 30 may also perform a part of data-processing operations which will be described later.

The processing unit 40 is configured to include processing equipment 41, a memory 42 and a display 43. The processing equipment 41 is configured with a computer, or a sequencer, or dedicated circuits, etc. and performs a whole or a part of the data-processing operations which will be described later. The memory 42 memorizes measurement results under the control of the processing equipment 41. The display 43 consists of, for example, a flat panel display, etc. and displays the measurement results under the control of the processing equipment 41.

In the present embodiment, the control equipment 30 and the processing equipment 41 are prepared separately, but it is possible to gather them and name them as one part, or it is also possible to integrate them into the same equipment.

The vehicle width/vehicle height measurement unit 50 is configured to include a plurality of the 2nd sensors 51, but FIG. 1 shows only one of them. A configuration of the 2nd sensors 51 is the same as that of the 1st sensors 25, 26 and the 2nd sensors 27, 28, 29. In FIG. 2, around the vehicle 4 running on the rails 3, a plurality of the 2nd sensors 51 are arranged as a gate shape and surrounding the side surfaces and the roof of the vehicle 4.

### Operations of Vehicle Size Measurement Apparatus

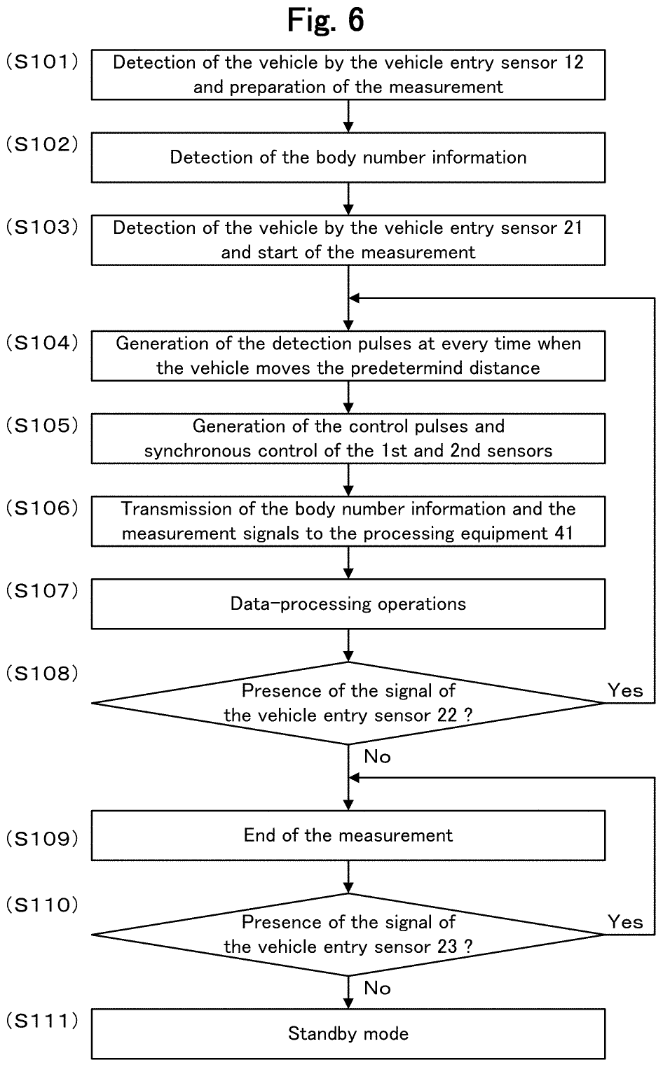

FIG. 6 is a flowchart showing operations of the vehicle size measurement apparatus according to the embodiment of the present invention. At first, when the vehicle 4 in FIG. 2 comes near the entrance of the train garage, the vehicle entry sensor 12 of the vehicle detection unit 10 detects the vehicle 4 and outputs a vehicle detection signal. The control equipment 30 receives the vehicle detection signal from the vehicle entry sensor 12 and makes preparation of the measurement by switching the whole apparatus from a standby mode to an operation mode (Step 101). The body number detection equipment 11 of the vehicle detection unit 10 detects the body number information given to the vehicle 4 (Step 102).

When a front portion of the vehicle 4 enters into the train garage, the vehicle entry sensor 21 of the height measurement unit 20 detects the vehicle 4 and outputs the vehicle detection signal. The control equipment 30 receives the vehicle detection signal from the vehicle entry sensor 21 and starts the measurement (Step 103). During the measurement, the vehicle position sensor 24 generates the detection pulses at every time when the vehicle 4 moves the predetermined distance, for example 1 mm (Step 104). The control equipment 30 carries out the synchronous control of the 1st sensors 25, 26, the 2nd sensor 27, 28, 29 and a plurality of the 2nd sensors 51 by generating control pulses based on the detection pulses outputted from the vehicle position sensor 24 (Step 105).

The control equipment 30 transmits the body number information detected by the body number detection equipment 11, the measurement signals output from the 1st sensors 25, 26, the measurement signals output from the 2nd sensors 27, 28, 29, and the measurement signals output from a plurality of the 2nd sensors 51 to the processing equipment 41 of the processing unit 40 using a communication line such as a wireless LAN, etc. (Step 106). Or, in the case where the control equipment 30 performs a part of the data-processing operations which will be described later, the control equipment 30 transmits processing results to the processing equipment 41 using the communication line such as the wireless LAN, etc. The processing equipment 41 performs a whole or a part of the data-processing operations which will be described later (Step 107).

When the vehicle 4 moves further, the vehicle entry sensor 22 of the height measurement unit 20 detects the vehicle 4 and outputs the vehicle detection signal. When the vehicle 4 moves further, the vehicle entry sensor 23 of the height measurement unit 20 detects the vehicle 4 and outputs the vehicle detection signal.

After receiving the vehicle detection signal from the vehicle entry sensor 22, the control equipment 30 checks presence or absence of the vehicle detection signal of the vehicle entry sensor 22 (Step 108). As far as the vehicle entry sensor 22 is detecting the vehicle 4, the control equipment 30 continues the measurement. When the vehicle 4 moves further and the vehicle entry sensor 22 does not detect the vehicle 4 anymore, the control equipment 30 ends the measurement (Step 109).

After that the control equipment 30 checks presence or absence of the vehicle detection signal of the vehicle entry sensor 23 (Step 110). When the whole body of the vehicle 4 enters into the train garage and the vehicle entry sensor 23 does not detect the vehicle 4 anymore, the control equipment 30 switches the vehicle detection unit 10, the height measurement unit 20, and the vehicle width/vehicle height measurement unit 50 to the standby mode (Step 111).

### Data-Processing Operations

Hereinafter, the data-processing operations will be explained in detail by taking a height measurement of the apparatus under the vehicle floor as an example, which is based on the measurement signals of the 1st sensors 25, 26, and the 2nd sensors 27, 28, 29 in the height measurement unit 20. By applying these data-processing operations to the measurement signals of a plurality of the 2nd sensors 51 in the vehicle width/vehicle height measurement unit 50, the outside sizes of the vehicle, such as a vehicle width, vehicle height, etc. will be measured. In the example, the processing equipment 41 performs a whole of the data-processing operations, but the control equipment 30 may also perform a part of the data-processing operations. The processing equipment 41 and the control equipment 30 process the data of the outside sizes of the vehicle with relating to the body number information detected by the body number detection equipment 11. With the body number information, the measurement result can be distinguished from results of other vehicles.

### The 1st Embodiment

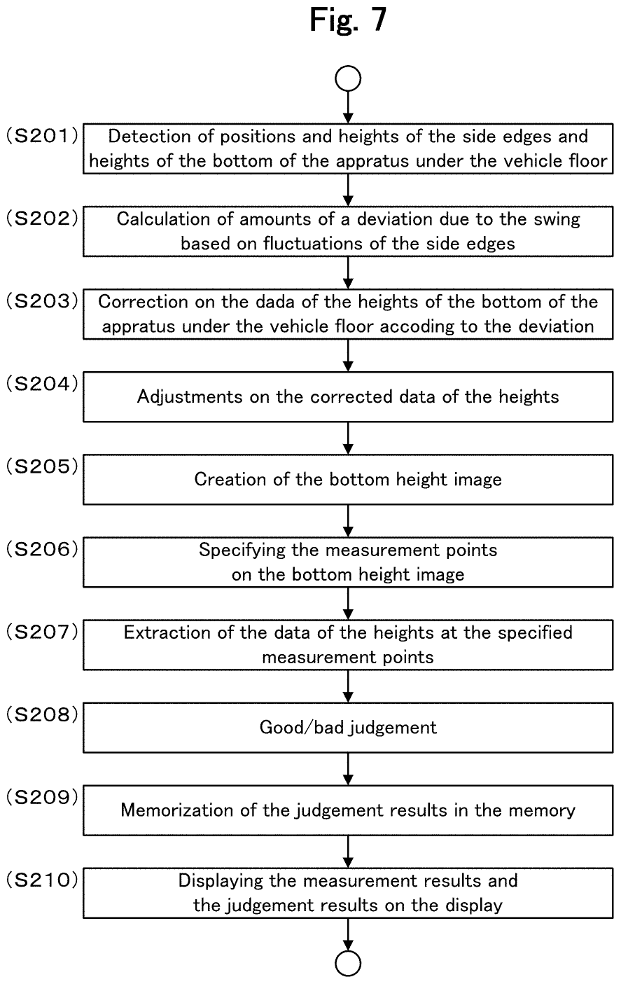

FIG. 7 is a flowchart of the data-processing operations according to the embodiment of the present invention. At first, the processing equipment 41 detects positions and heights of the side edges 4a in both sides of the vehicle 4 based on the measurement signals of the 1st sensors 25, 26. And the processing equipment 41 detects heights of the bottom of the apparatus under the vehicle floor at the same interval based on the measurement signals of the 2nd sensors 27, 28, 29 (Step 201). Next, the processing equipment 41 calculates amounts of a deviation of the bottom of the apparatus under the vehicle floor due to the swing of the vehicle 4 based on amounts of fluctuations of the detected positions and heights of the side edges 4a. (Step 202). Then the processing equipment 41 corrects the detected data of the heights of the bottom of the apparatus under the vehicle floor according to the calculated amount of the deviation (Step 203). The processing equipment 41 performs these operations on the whole data of the heights of the bottom of the apparatus under the vehicle floor, which are detected at the same interval.

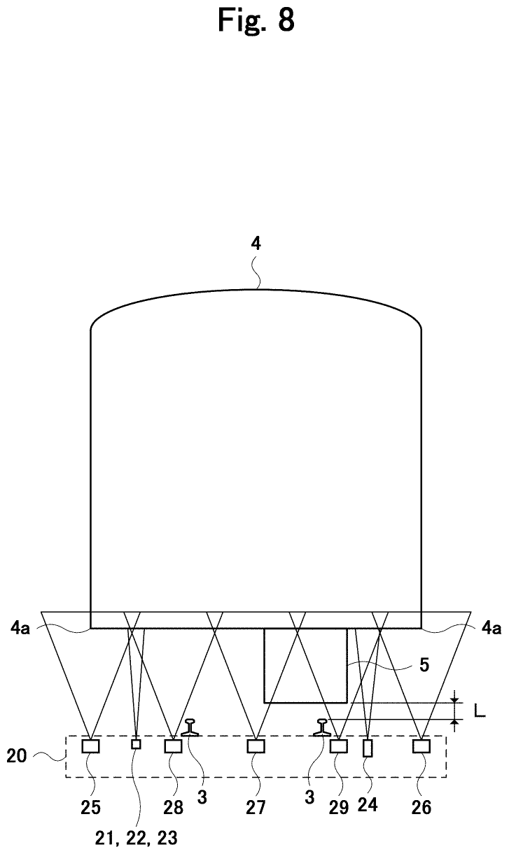

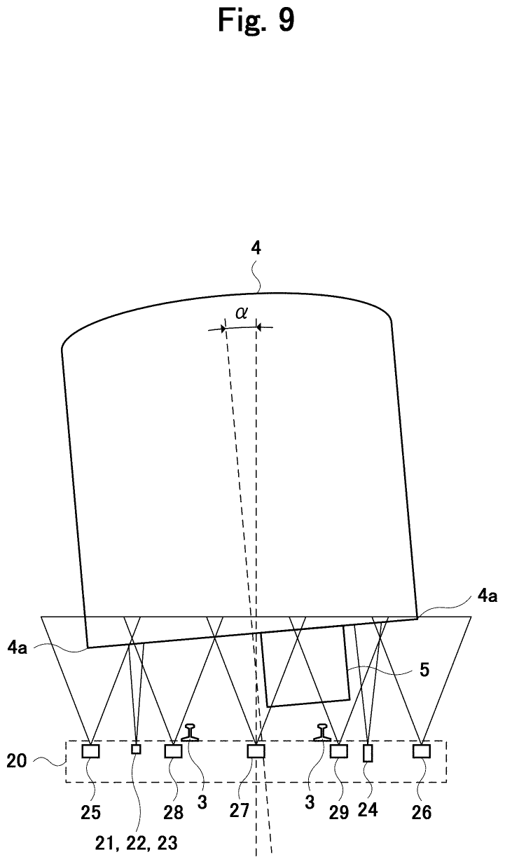

FIG. 8 is a diagram showing a state of the vehicle without the swing. When there is no swing of the vehicle 4, the height of the side edge 4a at the left side and the height of the side edge 4a at the right side are the same, and a distance L between the bottom of an apparatus 5 under the vehicle floor and a top surface of the rail 3 is constant. FIG. 9 is a diagram showing a state of the vehicle when the swing occurs. In the vehicle 4 under run, deviations of heights of the bottom of the apparatus 5 under the vehicle floor occur due to gaps in upper/lower and left-side/right-side directions or an inclination, which are caused by the swing of the vehicle 4. As shown in FIG. 9, for example, when the vehicle 4 inclines at an angles, the height of the side edge 4a at the left side and the height of the side edge 4a at the right side become different, a deviation of the height of the bottom of the apparatus 5 under the vehicle floor occurs. Amounts of the deviations of the bottom of the apparatus 5 under the vehicle floor due to the swing of the vehicle 4 vary depending on swinging levels of the vehicle 4, installation positions and a height size of the apparatus 5 under the vehicle floor.

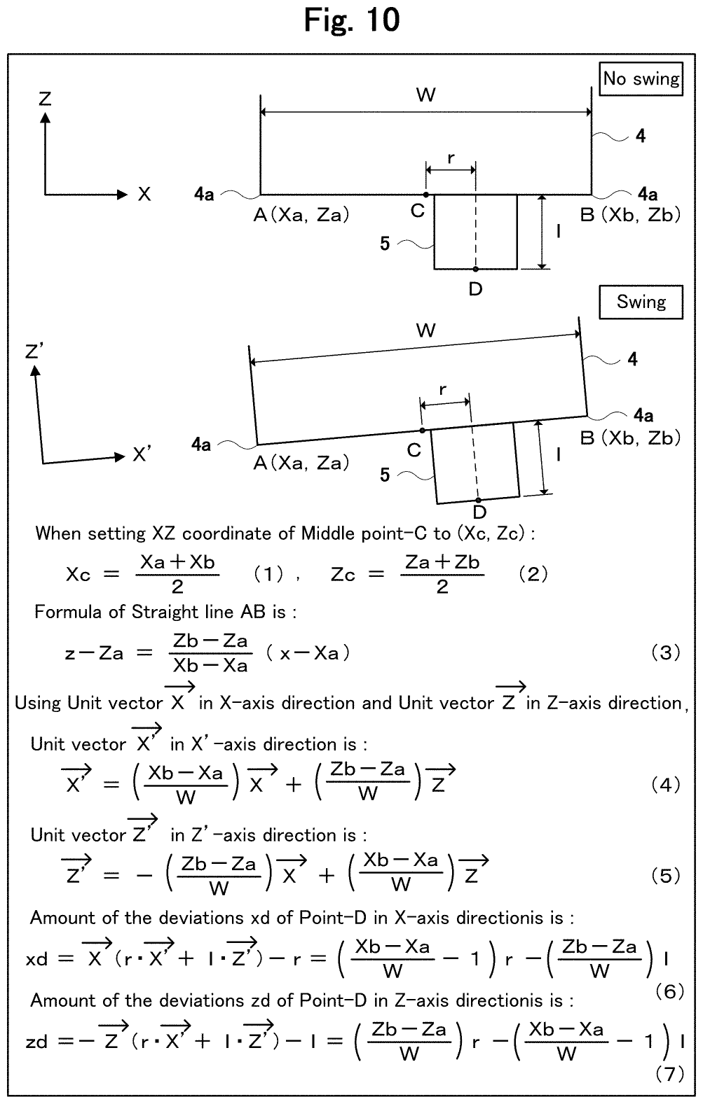

FIG. 10 is a drawing for explaining how to calculate the amounts of the deviation of the bottom of the apparatus under the vehicle floor due to the swing of the vehicle. X-axis is in a rails width direction, and Z-axis is in a height direction. Point-A is the side edge 4a of the vehicle 4 in the left side, and its XZ coordinate is (Xa, Za). Point-B is the side edge 4a of the vehicle 4 in the right side, and its XZ coordinate is (Xb, Zb). When setting a XZ coordinate of Middle point-C between Point-A and Point-B to (Xc, Zc), Formula (1) and Formula (2) are applied. When there is no swing of the vehicle 4 as shown in FIG. 8, Za=Zb=Zc. When the swing of the vehicle 4 occurs, a coordinate (x, z) of a point on Straight line AB is applied to Formula (3).

Distance-r in an X-axis direction between Middle point-C and Point-D, which is on the bottom of the apparatus 5 under the vehicle floor, shows the installation positions of the apparatus 5 under the vehicle floor in the rails width direction seeing from Middle point-C. Height size-l shows the height size of the apparatus 5 under the vehicle floor. Distance-W is a distance between Point-A and Point-B. The memory 42 in the processing equipment 41 memorizes the data of Distances-W, Distances-r and Height sizes-l of all apparatus 5 under the vehicle floor installed on the vehicle,

Unit vectors in the X-axis direction and in a Z-axis direction are set as shows in FIG. 10. When X-axis inclines and becomes X′-axis, also Z-axis inclines and becomes Z′-axis due to the swing of the vehicle 4, a unit vector in a X′-axis direction is applied to Formula (4), and a unit vector in a Z′-axis direction is applied to Formula (5). Therefore, the amounts of the deviation xd of Point-D, which is on the bottom of the apparatus 5 under the vehicle floor, in the X-axis direction seeing from Point-C is calculated using Formula (6), and the amounts of the deviation zd of Point-D in the Z-axis direction seeing from Point-C is calculated using Formula (7). The processing equipment 41 calculates the amounts of the deviation of the bottom of the apparatus 5 under the vehicle floor based on the data of Distance-W, Distance-r and Height size-l memorized in the memory 42 using Formulas (6) and (7).

In the present embodiment, the processing equipment 41 detects the positions and the heights of the side edges 4a in both sides of the vehicle 4 based on the measurement signals of the 1st sensors 25, 26, but it is possible to detect positions and heights of a plurality of other places of the vehicle 4. By calculating the amounts of the deviation of the bottom of the apparatus under the vehicle floor due to the swing of the vehicle 4 based on the amounts of the fluctuations of the detected positions and heights of a plurality of the places of the vehicle 4 (Step 202 in FIG. 7), and by correcting the detected data of the heights of the bottom of the apparatus under the vehicle floor according to the calculated amount of the deviation (Step 203), the heights of the bottom of the apparatus under the vehicle floor can be measured accurately without any influence of the swing of the vehicle 4 under run.

At this time, the amounts of the deviation of the bottom of the apparatus under the vehicle floor due to the swing of the vehicle 4 are changing time after time depending on a travelling movement of the vehicle 4. In the present embodiment, by carrying out the synchronous control of a plurality of the 1st sensors 25, 26 and the 2nd sensors 27, 28, 29 (Step 105 in FIG. 6) based on the detection pulses outputted from the vehicle position sensor 24, which are generated at every time when the vehicle 4 moves the predetermined distance (Step 104), the amounts of the deviation of the bottom of the apparatus under the vehicle floor due to the swing of the vehicle 4 can be measured accurately.

Next in FIG. 7, the processing equipment 41 performs adjustments in a perpendicular direction on the corrected data of the heights of the bottom of the apparatus under the vehicle floor (Step 204). In these adjustments, for example, a middle point of the side ledge 4a in the left side and the side edge 4a in the right side in a front/rear view of the vehicle 4 is set as a datum point beforehand, and the corrected data of the heights of the bottom of the apparatus under the vehicle floor is converted to the data of perpendicular distances from the datum point. Then the processing equipment 41 creates a bottom height image, which shows the distribution of the heights of the bottom of the apparatus under the vehicle floor, using the adjusted data of the heights (Step 205). The bottom height image can be obtained accurately without any influence of the swing of the vehicle. Therefore, it is possible to detect differences by comparing this image with another image which was created about the same vehicle before.

Next, the processing equipment 41 specifies the measurement points, which are pointed out beforehand, on the created bottom height image (Step 206), and extracts the data of the heights of the bottom of the apparatus under the vehicle floor at the specified measurement points (Step 207). By creating the bottom height image and specifying the measurement points, which is pointed out beforehand, on the created bottom height image, the inspection worker can arbitrarily point out the measurement points before the inspection using the vehicle size measurement apparatus 100. When pointing out the measurement points, is possible to use, for example, a bottom height image which was created about the same vehicle before.

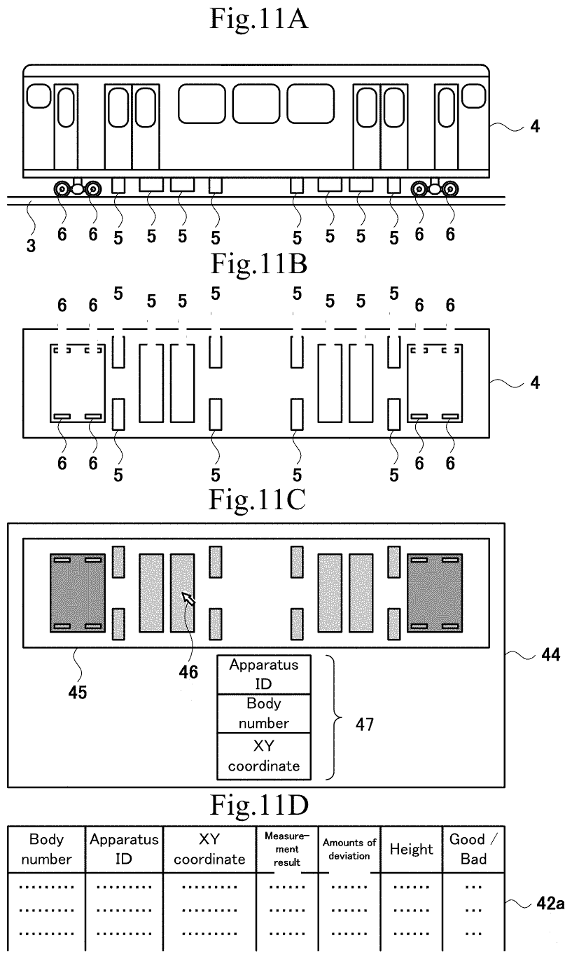

FIG. 11 is a drawing for explaining an example way of pointing out the measurement points. FIG. 11A is a side view of the vehicle and FIG. 11B is a bottom view of the vehicle. In FIGS. 11A and 11B, the apparatuses 5 under the vehicle floor are installed under the floor of the vehicle 4, and wheels 6 are prepared on a bogie frame which is not shown in FIGS. 11B and 11B. FIG. 11C shows a display screen of the display 43. In the display screen 44, a bottom height image 45, which was created about the same vehicle before, is displayed. The inspection worker moves an icon 46 and points out the measurement points on the bottom height image 45 using the icon 46. In the display screen 44, displayed data 47 shows an apparatus ID, a body number and XY coordinate of the pointed-out measurement point.

Next in FIG. 7, the processing equipment 41 judges whether the heights of the bottom of the apparatus under the vehicle floor at the measurement points are less than a predetermined value from a datum point which was beforehand set on the vehicle (Step 208), and memorizes judgment results in the memory 42 (Step 209). Since in the vehicle under run as mentioned above, the deviations of the heights of the bottom of the apparatus under the vehicle floor occur due to the swing of the vehicle 4, the conventional way of judging good/bad of the measurement result based on the height of the upper surface of the rail 3 is not suitable. Therefore, the measurement result is judged good or bad based on a distance from the datum point which was beforehand set on the vehicle. The datum point used in the adjustments of Step 204 can be also used as this datum point. The predetermined value can be varies depending on kinds of the apparatus under the vehicle floor or installation positions of the apparatus under the vehicle floor. The good/bad judgement of the measurement result can be checked with the data memorized in the memory 42.

FIG. 11D shows an example of the data memorized in the memory 42. In this example, as shown in a data table 42a, the body number, the apparatus ID, XY coordinate, the measurement result, the amount of the deviation, the corrected height, and the good/bad judgement result of each measurement point are memorized in the memory 42.

Next in FIG. 7, the processing equipment 41 displays the judgement results together with the measurement results on the display 43 (Step 210). Therefore, the inspection worker can easily know the good/bad judgement of the measurement result by checking displayed contents.

### The 2nd Embodiment

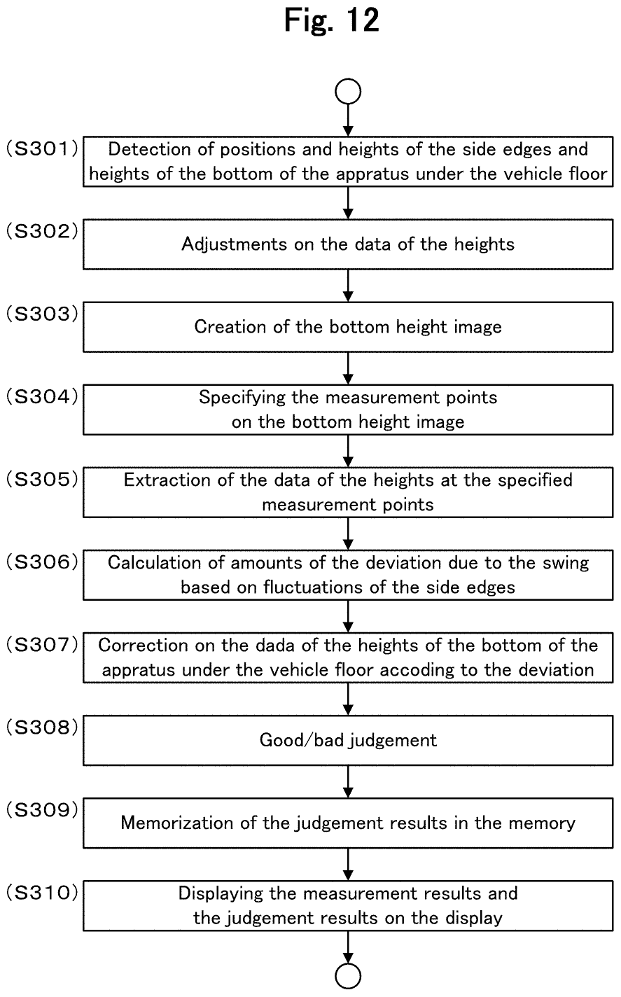

FIG. 12 is a flowchart of the data-processing operations according to another embodiment of the present invention. In this embodiment, a difference from the 1st embodiment is not correcting all the detected data of the heights of the bottom of the apparatus under the vehicle floor at the same interval according to the amount of the deviation due to the swing of the vehicle 4, but correcting only the specified and extracted data after creating the bottom height image.

At first, the processing equipment 41 detects the positions and the heights of the side edges 4a in both sides of the vehicle 4 based on the measurement signals of the 1st sensors 25, 26. And the processing equipment 41 detects the heights of the bottom of the apparatus under the vehicle floor at the same interval based on the measurement signals of the 2nd sensors 27, 28, 29 (Step 301). Next, the processing equipment 41 performs adjustments in a perpendicular direction on the detected data of the heights of the bottom of the apparatus under the vehicle floor (Step 302). In these adjustments, for example, a middle point of the side ledge 4a in the left side and the side edge 4a in the right side in a front/rear view of the vehicle 4 is set as a datum point beforehand, and the data of the heights of the bottom of the apparatus under the vehicle floor is converted to the data of perpendicular distances from the datum point. Then the processing equipment 41 creates a bottom height image, which shows the distribution of the heights of the bottom of the apparatus under the vehicle floor, using the adjusted data of the heights (Step 303).

Next, the processing equipment 41 specifies the measurement points, which are pointed out beforehand, on the created bottom height image (Step 304), and extracts the data of the heights of the bottom of the apparatus under the vehicle floor at the specified measurement points (Step 305). By creating the bottom height image and specifying the measurement points, which are pointed out beforehand, on the created bottom height image, the inspection worker can arbitrarily point out the measurement points before the inspection using the vehicle size measurement apparatus 100. When pointing out the measurement points, for example, a map showing positions under the floor of the vehicle 4 can be used, or the inspection worker may input XY coordinate of the measurement points. Or, it is possible to prepare a line-sensor in addition to the 1st sensors 25, 26 and the 2nd sensors 27, 28, 29 for obtaining a 2-dimensional image of the bottom of the vehicle 4 and to point out the measurement points using the 2-dimensional image created before.

Next, the processing equipment 41 calculates the amounts of the deviation of the bottom of the apparatus under the vehicle floor due to the swing of the vehicle 4 based on amounts of fluctuations of the positions and the heights of the side edges 4a, which are detected when measuring the specified measurement points (Step 306). Then the processing equipment 41 corrects the data of the heights of the bottom of the apparatus under the vehicle floor at the measurement points according to the calculated amount of the deviation (Step 307). In the present embodiment, comparing with a case of correcting all the detected data of the heights of the bottom of the apparatus under the vehicle floor at the same interval according to the amount of the deviation due to the swing of the vehicle 4, amounts of the processing data can be reduced.

Next, the processing equipment 41 judges whether the heights of the bottom of the apparatus under the vehicle floor at the measurement points are less than a predetermined value from a datum point which was beforehand set on the vehicle (Step 308), and memorizes a judgment results in the memory 42 (Step 309). The good/bad judgement of the measurement result can be checked with the data memorized in the memory 42. Next, the processing equipment 41 displays the judgement results together with the measurement results on the display 43 (Step 310). Therefore, the inspection worker can easily know the good/bad judgement of the measurement result by the checking displayed contents.

In the above explained data-processing operations, a whole or a part of Steps 201-208 in FIG. 7 or Steps 301-308 in FIG. 12 may be performed by the control equipment 30 on behalf of the processing equipment 41, and processing results may be transmitted to the processing equipment 41 using the communication line such as the wireless LAN, etc. By these, the required capacity of the communication line can be smaller.

### Effect of the Embodiments

According to the above described embodiments, the following effects are obtained.

(1) It is possible to measure the outside size of the vehicle accurately while running the vehicle.

(2) Furthermore, by using the body number detection equipment 11, detecting the body number information given to the vehicle, and processing the data of the outside size of the vehicle with relating to the body number information detected by the body number detection equipment 11, the measurement result can be distinguished from results of other vehicles.

(3) Furthermore, by using the vehicle position sensor 24, detecting the position of the vehicle, outputting the detection pulses at every time when the vehicle moves the predetermined distance, and carrying out the synchronous control of the 1st sensors 25, 26, the 2nd sensor 27, 28, 29 and a plurality of the 2nd sensors 51 based on the detection pulses outputted from the vehicle position sensor 24, the mounts of the deviation of the outside surfaces of the vehicle due to the swing of the vehicle can be measured accurately.

(4) Furthermore, by using the 2nd sensors 27, 28, 29, irradiating the inspection lights below to the floor of the vehicle, outputting the measurement signals which show the positions and the distances by receiving the lights below from the floor of the vehicle, processing the measurement signals outputted from the 2nd sensors 27, 28, 29, and detecting the heights of the bottom of the apparatus under the vehicle floor, which is prepared under the floor of the vehicle, the heights of the bottom of the apparatus under the vehicle floor can be measured accurately while running the vehicle.

(5) Furthermore, by creating the bottom height image which shows the distribution of the heights of the bottom of the apparatus under the vehicle floor, and specifying the measurement points, which is pointed out beforehand, on the created bottom height image, the inspection worker can arbitrarily point out the measurement points beforehand.

(6) Furthermore, by preparing the memory 42 which memorizes the data of the heights of the bottom of the apparatus under the vehicle floor, judging whether the measured heights of the bottom of the apparatus under the vehicle floor are less than the predetermined value from the datum point which was beforehand set on the vehicle, and memorizing the judgment results in the memory 42, the good/bad judgement of the measurement result can be checked with the data memorized in the memory 42.

(7) Furthermore, by preparing the display 43 which displays the heights of the bottom of the apparatus under the vehicle floor, and displaying the judgment results on the display 43, the inspection worker can easily know the good/bad judgement of the measurement result by checking the displayed contents.

Furthermore, according to the 1st embodiment shown in FIG. 7, the following effects are obtained.

(8) By creating the bottom height image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of the vehicle, the bottom height image can be obtained accurately without any influence of the swing of the vehicle. Therefore, it is possible to detect differences by comparing the image with another image which was created about the same vehicle before.

Furthermore, according to the 2nd embodiment shown in FIG. 12, the following effects are obtained:

(9) Comparing with a case of correcting all the detected data of the heights of the bottom of the apparatus under the vehicle floor at the same interval according to the amount of the deviation due to the swing of the vehicle, the amounts of the processing data can be reduced.

By measuring the outside size of the vehicle using the vehicle size measurement apparatus and the vehicle size measuring method according to the present invention, and then carrying out a check by worker's hand only when the measured value exceeds a predetermined value, it is possible to reduce time and efforts of inspection and maintenance works. Furthermore, by frequently measuring the outside size of the vehicle using the vehicle size measurement apparatus and the vehicle size measuring method according to the present invention and analyzing the measured data, it is possible to detect a bad omen of any trouble such as a loosening of the apparatus under the vehicle floor.

The 1st sensors and the 2nd sensor used in the present invention are not limited to an element which receives a reflection light from the vehicle, but also applied to an element which receives a scattering light from the vehicle.

In the embodiments described above, the positions and the heights of two places of the vehicle are detected using two of the 1st sensors, but it is possible to prepare three or more of the 1st sensors and detect three or more places of the vehicle.

Furthermore, in the embodiments described above, three of the 2nd sensors, which detect the height of the bottom of the apparatus under the vehicle floor, are prepared, but the number and the arrangement of the 2nd sensor are not limited to the embodiments. As the same, the number and the arrangement of the vehicle entry sensor, which detects presence or absence of the vehicle, are not limited to the embodiments. Also, the number and the arrangement of a plurality of the 2nd sensors in the vehicle width/vehicle height measurement unit are not limited to the embodiments.

### DESCRIPTION OF THE REFERENCE NUMERALS

3 Rail
4 Vehicle
4a Side edge
5 Apparatus under the vehicle floor
6 Wheel
10 Vehicle detection unit
10a Light irradiating portion
10b Light receiving portion
11 Body number detection equipment
12 Vehicle entry sensor
20 Height measurement unit
21, 22, 23 Vehicle entry sensor
24 Vehicle position sensor
25, 26 1st sensor
25a Laser light source
25b Condenser lens
25c Light receiving element
27, 28, 29 2nd sensor
30 Control equipment
40 Processing unit
41 Processing equipment
42 Memory
42a Data table
43 Display
44 Display screen
45 Bottom height image
46 Icon
47 Displayed data
50 Vehicle width/vehicle height measurement unit
51 2nd sensor
100 Vehicle size measurement apparatus

1. A vehicle size measurement apparatus, wherein said apparatus comprising:
a plurality of the 1st sensors which irradiate inspection lights to a plurality of places of a vehicle of a railroad and output measurement signals which show positions and distances by receiving lights from a plurality of the places of said vehicle,
the 2nd sensor which irradiates an inspection light to an outside surface of said vehicle and outputs a measurement signal which shows a position and a distance by receiving a light from the outside surface of said vehicle, and
control and processing equipment which controls a plurality of said 1st sensors and said 2nd sensor, processes said measurement signal outputted from said 2nd sensor, and detects an outside size of said vehicle, wherein
said control and processing equipment processes said measurement signals outputted from a plurality of said 1st sensors, detects positions and heights of a plurality of the places of said vehicle, calculates amounts of a deviation of the outside surface of said vehicle due to a swing of said vehicle based on amounts of fluctuations of the detected positions and heights of a plurality of the places of said vehicle, and corrects the detected outside size of said vehicle according to the calculated amounts of the deviation.

2. The vehicle size measurement apparatus as claimed in claim 1,
said apparatus further comprises body number detection equipment which detects the body number information given to said vehicle, wherein
said control and processing equipment processes the data of the outside size of said vehicle with relating to said body number information detected by said body number detection equipment.

3. The vehicle size measurement apparatus as claimed in claim 1,
said apparatus further comprises a vehicle position sensor which detects a position of said vehicle and outputs detection signals at every time when said vehicle moves a predetermined distance, wherein
said control and processing equipment carries out a synchronous control of a plurality of said 1st sensors and said 2nd sensor based on the detection signals outputted from said vehicle position sensor.

4. The vehicle size measurement apparatus as claimed in claim 1, wherein,
said 2nd sensor irradiates the inspection light below to a floor of said vehicle and outputs the measurement signal which shows the position and the distance by receiving the light below from the floor of said vehicle, and
said control and processing equipment processes said measurement signal outputted from said 2nd sensor and detects a height of the bottom of an apparatus under the vehicle floor, which is prepared under the floor of said vehicle.

5-6. (canceled)

7. The vehicle size measurement apparatus as claimed in claim 4, wherein,
said control and processing equipment processes the measurement signal outputted from said 2nd sensor and detects the heights of the bottom of the apparatus under the vehicle floor at the same interval, creates an image which shows the distribution of the heights of the bottom of the apparatus under the vehicle floor, and specifies measurement points, which are pointed out beforehand, on the created image.

8-9. (canceled)

10. The vehicle size measurement apparatus as claimed in claim 7, wherein,
said control and processing equipment creates the image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of said vehicle.

11-12. (canceled)

13. The vehicle size measurement apparatus as claimed in claim 4,
said apparatus further comprises a memory which memorizes the data of the height of the bottom of the apparatus under the vehicle floor, wherein
said control and processing equipment judges whether the measured height of the bottom of the apparatus under the vehicle floor is less than a predetermined value from a datum point which was beforehand set on said vehicle, and memorizes a judgment result in said memory.

14-21. (canceled)

22. The vehicle size measurement apparatus as claimed in claim 13,
said apparatus further comprises a display which displays the height of the bottom of the apparatus under the vehicle floor, wherein
said control and processing equipment displays said judgment result on said display.

23-30. (canceled)

31. A vehicle size measuring method, wherein said method comprising the following steps of:
using a plurality of the 1st sensors, irradiating inspection lights to a plurality of places of a vehicle of a railroad and outputting measurement signals which show positions and distances by receiving lights from a plurality of the places of said vehicle,
using the 2nd sensor, irradiating an inspection light to an outside surface of said vehicle and outputting a measurement signal which shows a position and a distance by receiving a light from the outside surface of said vehicle,
processing said measurement signals outputted from a plurality of said 1st sensors and detecting positions and heights of a plurality of the places of said vehicle,
processing said measurement signal outputted from said 2nd sensor and detecting an outside size of said vehicle, and
calculating amounts of a deviation of the outside surface of said vehicle due to a swing of said vehicle based on amounts of fluctuations of the detected positions and heights of a plurality of the places of said vehicle and correcting the detected outside size of said vehicle according to the calculated amounts of the deviation.

32. The vehicle size measuring method as claimed in claim 31, wherein said method further comprising the following steps of:
using body number detection equipment, detecting the body number information given to said vehicle, and
processing the data of the outside size of said vehicle with relating to said body number information detected by said body number detection equipment.

33. The vehicle size measuring method as claimed in claim 31, wherein said method further comprising the following steps of:
using a vehicle position sensor, detecting a position of said vehicle and outputting detection signals at every time when said vehicle moves a predetermined distance, and
carrying out a synchronous control of a plurality of said 1st sensors and said 2nd sensor based on the detection signals outputted from said vehicle position sensor.

34. The vehicle size measuring method as claimed in claim 31, wherein said method further comprising the following steps of:
using said 2nd sensor, irradiating the inspection light below to a floor of said vehicle and outputting the measurement signal which shows the position and the distance by receiving the light below from the floor of said vehicle, and
processing said measurement signal outputted from said 2nd sensor and detecting a height of the bottom of an apparatus under the vehicle floor, which is prepared under the floor of said vehicle.

35-36. (canceled)

37. The vehicle size measuring method as claimed in claim 34, wherein said method further comprising the following steps of:
processing the measurement signal outputted from said 2nd sensor and detecting the heights of the bottom of the apparatus under the vehicle floor at the same interval,
creating an image which shows the distribution of the heights of the bottom of the apparatus under the vehicle floor, and
specifying measurement points, which are pointed out beforehand, on the created image.

38-39. (canceled)

40. The vehicle size measuring method as claimed in claim 37, wherein said method further comprising the following steps of:
creating the image which shows the distribution of the heights of the bottom of the apparatus under the vehicle floor after correcting the detected data of the heights of the bottom of the apparatus under the vehicle floor at the same interval according to the amount of the deviation of the bottom of the apparatus under the vehicle floor due to the swing of said vehicle.

41-42. (canceled)

43. The vehicle size measuring method as claimed in claim 34, wherein said method further comprising the following steps of:
preparing a memory which memorizes the data of the height of the bottom of the apparatus under the vehicle floor, and
judging whether the measured height of the bottom of the apparatus under the vehicle floor is less than a predetermined value from a datum point which was beforehand set on said vehicle, and memorizing a judgment result in said memory.

44-51. (canceled)

52. The vehicle size measuring method as claimed in claim 43, wherein said method further comprising the following steps of:
preparing a display which displays the height of the bottom of the apparatus under the vehicle floor, and
displaying said judgment result on said display.

53-60. (canceled)
